(19) United States
(12) Patent Application Publication
(10) Pub. No.: US 2010/0041437 A1
(43) Pub. Date: Feb. 18, 2010

(54) COMMUNICATION APPARATUS

(75) Inventors: Minoru Maeda, Kawasaki (JP); Katsuaki AKAMA, Kawasaki (JP); Takashi UEKI, Kawasaki (JP); Rongcai HU, Beijing (CN)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/566,152

(22) Filed: Sep. 24, 2009

Related U.S. Application Data
(63) Continuation of application No. PCT/JP2007/057190, filed on Mar. 30, 2007.

(51) Int. Cl. H04M 1/00

(52) U.S. Cl. 455/558

(57) ABSTRACT

A communication apparatus for communicating with another apparatus via a network, includes: a storage unit for storing identification information of a plurality of networks and areas where the networks are deployed, respectively, and information of time periods while communication over the networks is permissible for the communication apparatus, respectively; a processor to control communication with the another apparatus in accordance with a process including: selecting one of the networks which is currently connectable and available to communicate with the another apparatus on the basis of the identification information of the networks and the areas; determining whether the present time is within one of the time periods; and either inhibiting communication with the another apparatus via the selected network when the present time is not within the period of time, or allowing communication with the another apparatus via the selected network when the present time is within the period of time.

### CROSS-REFERENCE TO RELATED APPLICATION

This is a continuation of Application PCT/JP2007/057190, filed on Mar. 30, 2007, the entire contents of which are incorporated herein by reference.

### FIELD

A certain aspect of the embodiments discussed herein relates to a communication apparatus.

### BACKGROUND

With growing globalization, cellular phones in which roaming is enabled have come into use. International roaming in a cellular phone is performed by selecting and setting a country code (MCC: Mobile Country Code) and a network code (MNC: Mobile Network Code) stored in the cellular phone. This enables a user to, for example, make a call even overseas, using the user's information.

However, for example, in a case where a cellular phone is stolen during an international roaming service, a problem such as damage including high charge for a call due to illegal use arises.

Japanese Laid-open Patent Publication No. 2004-151772 discloses a roaming method for cellular phones.

### SUMMARY

According to an aspect of an embodiment, a communication apparatus for communicating with another apparatus via a network, the communication apparatus includes: a storage unit for storing identification information of a plurality of networks and areas where the networks are deployed, respectively, and information of time periods while communication over the networks is permissible for the communication apparatus, respectively; a processor to control communication with the another apparatus in accordance with a process including: selecting one of the networks which is currently connectable and available to communicate with the another apparatus on the basis of the identification information of the networks and the areas; determining whether the present time is within one of the time periods for the selected one of the networks; and either inhibiting communication with the another apparatus via the selected network when the present time is not within the period of time, or allowing communication with the another apparatus via the selected network when the present time is within the period of time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a hardware block diagram of a communication device 100 according to an embodiment.

FIG. 2 is a functional block diagram of a USIM 110 according to the embodiment.

FIG. 3 illustrates a user preferential network selection information file 300 according to the embodiment.

FIG. 4 illustrates a mobile equipment number file 400 according to the embodiment.

FIG. 5 illustrates a last time information file 500 according to the embodiment.

FIG. 6 is a sequence diagram of writing IMEI according to the embodiment.

FIG. 7 is a sequence diagram of setting time information according to the embodiment.

FIG. 8 is a sequence diagram of updating time information according to the embodiment.

FIG. 9 is a sequence diagram of registering user preferential network selection information according to the embodiment.

FIG. 10 is a flowchart of an operation of reading roaming information according to the embodiment.

FIG. 11 is a flowchart of selection in an operation of selecting PLMN according to the embodiment.

FIG. 12 is a flowchart of an operation of updating a PLMN table according to the embodiment.

FIG. 13 illustrates roaming information 1300 according to the

### DESCRIPTION OF EMBODIMENTS

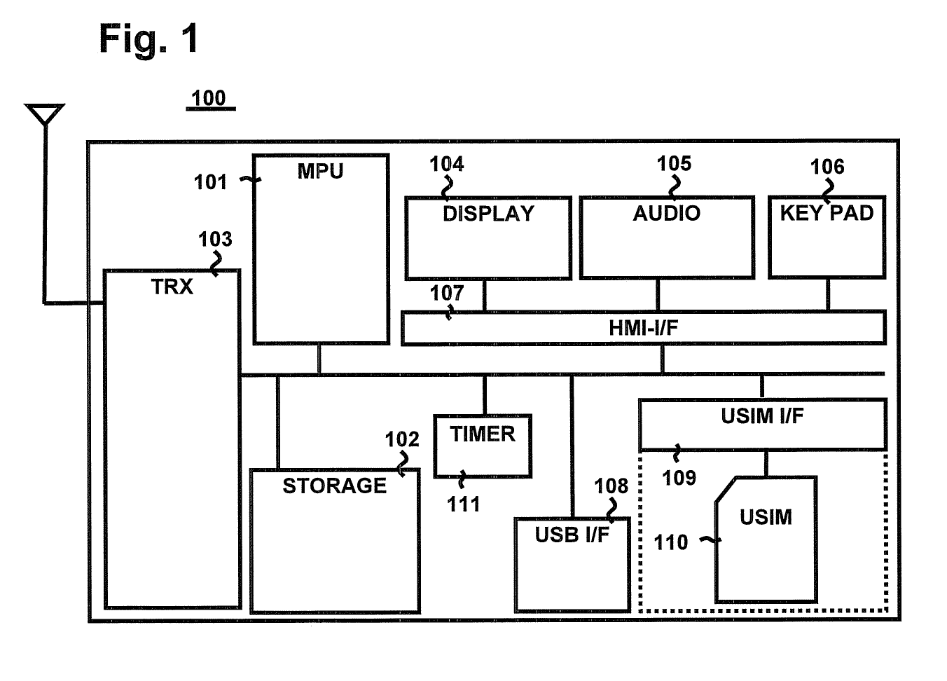

FIG. 1 is a hardware block diagram of a cellular phone 100 according to an embodiment.

In the embodiment, the description will be given, taking a cellular phone as an exemplary communication device. However, the communication device is not limited to a cellular phone and may be a communication device such as a personal digital assistant (PDA).

The cellular phone 100 includes a micro processing unit (MPU) 101, a storage unit (ROM/RAM) 102, a transmitter and receiver unit (TRX) 103, a display unit (Main-LCD/Sub-LCD) 104, an audio processing unit (Audio) 105, an operation unit (Key-pad) 106, an HMI interface (HMI-I/F) 107, a USB interface (USB I/F) 108, a USIM interface (USIM I/F) 109, a Universal Subscriber Identity Module (USIM) 110, and a timer (TIMER) 111.

The MPU 101 performs various types of control of, for example, the storage unit 102, the transmitter and receiver unit 103, the display unit 104, the audio unit 105, and the operation unit 106. The MPU 101 further controls reading data stored in an external device connected to the USB interface 108 and the USIM 110 and writing data to the USIM 110. These control operations are performed by, for example, execution of a control program stored in a ROM included in the MPU 101. In this case, a place where the control program is stored is not limited to a ROM and may be another recording medium equivalent to a ROM. In the embodiment, the cellular phone 100 includes, though not limited to, the single MPU 101, and the MPU 101 performs overall control of the cellular phone 100. For example, the cellular phone 100 may include another MPU in addition to the MPU 101, the MPU 101 may perform communication control, and the other MPU may control applications installed in the cellular phone 100.

The storage unit 102 represents a ROM, a RAM, and the like as a whole and may include a detachable recording medium. The storage unit 102 may include, for example, a flash memory as a memory in which stored content is not lost even when the power is released. Moreover, application programs executable in the cellular phone 100 and the like are stored in the storage unit 102, and the MPU 101 controls the cellular phone 100 by executing the application programs.

The transmitter and receiver unit 103 transmits and/or receives radio beams through an antenna. The transmitter and receiver unit 103 generates radio beams to be transmitted and received by, for example, modulating and demodulating carrier signals that include signals expressing images, speech signals, dial signals, and the like.

The display unit 104 includes, for example, liquid crystal display (LCD) elements and displays various types of input information and output information for the MPU 101. In terms of hardware, the display unit 104 may include a plurality of LCDs. For example, the display unit 104 may include a main LCD and a sub LCD.

The audio processing unit 105 includes a microphone and a speaker. The audio processing unit 105 converts analog audio signals captured from the microphone to digital signals and converts digital audio signals output from the MPU 101 to analog signals. The speaker is used to output, for example, audio signals output from the MPU 101 and audio signals captured through the microphone.

The operation unit 106 includes a numeric keypad, a talk key, an end key, function keys, a cross key, and the like. A user can perform a call operation and operations of transmitting and receiving mails, using the operation unit 106. Moreover, the MPU 101 controls the display unit 104, the audio processing unit 105, and the operation unit 106 via the HMI interface 107.

The USB interface 108 is used to connect to an external device. For example, the MPU 101 controls an external device a connection to which is established via the USB interface 108.

The USIM 110 is installed in the cellular phone 100 via the USIM interface 109. The USIM 110 can be attached and detached to and from the cellular phone 100. In the USIM 110, for example, the telephone number of a user and information on a contracted carrier are recorded. The cellular phone 100 can be used by the use of user information such as a telephone number stored in the USIM 110 by attaching the USIM 110 to the cellular phone 100 by connecting the USIM 110 to the USIM interface 109.

The timer 111 implements a clock function and measures a time from set date and a set time.

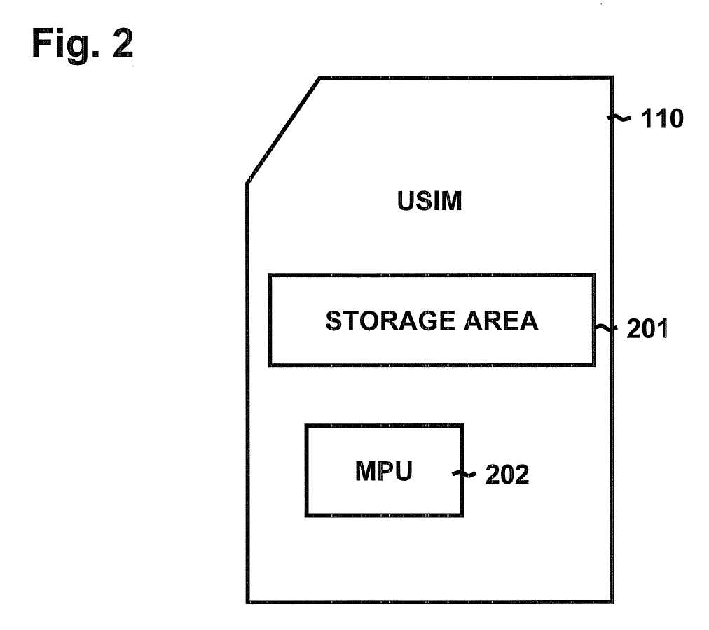

FIG. 2 is a functional block diagram of the USIM 110 according to the embodiment.

The USIM 110 includes a storage area 201 and an MPU 202. The telephone number, personal information, and the like of a user are stored in the storage area 201. Moreover, the cellular phone 100 has a roaming function in which services by a contracted carrier can be received by the use of facilities of an overseas affiliate carrier.

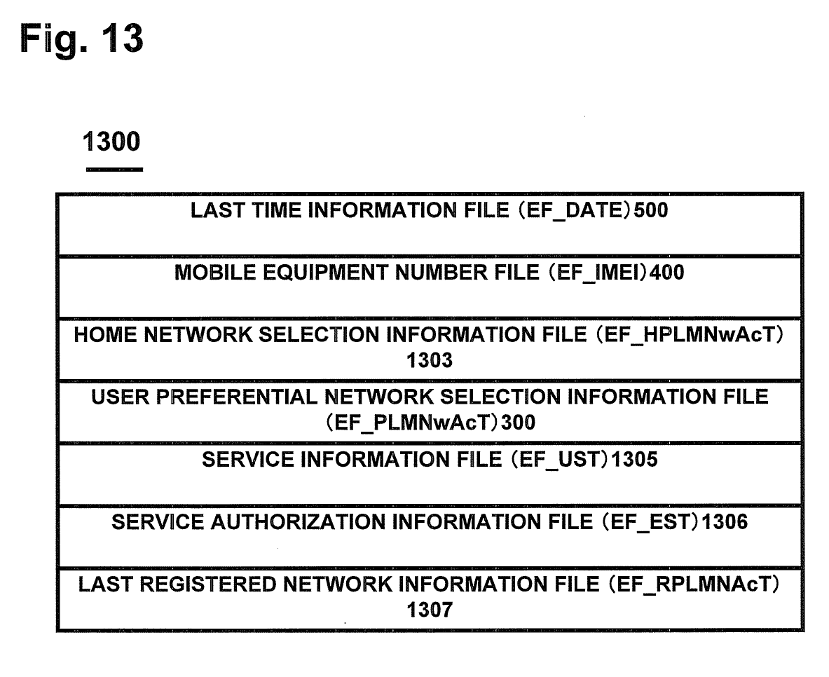

The storage area 201 of the USIM 110 stores roaming information 1300, illustrated in FIG. 13, necessary for the cellular phone 100 to use a roaming function. FIG. 13 illustrates the roaming information 1300 according to the embodiment. The roaming information 1300 includes a last time information file (EF_DATE) 500, a mobile equipment number file (EF_IMEI) 400, a home network selection information file (EF_HPLMNwAcT) 1303, a user preferential network selection information file (EF_PLMNwAcT) 300, a service information file (EF_UST) 1305, a service authorization information file (EF_EST) 1306, and a last registered network information file (EF_RPLMNAcT) 1307.

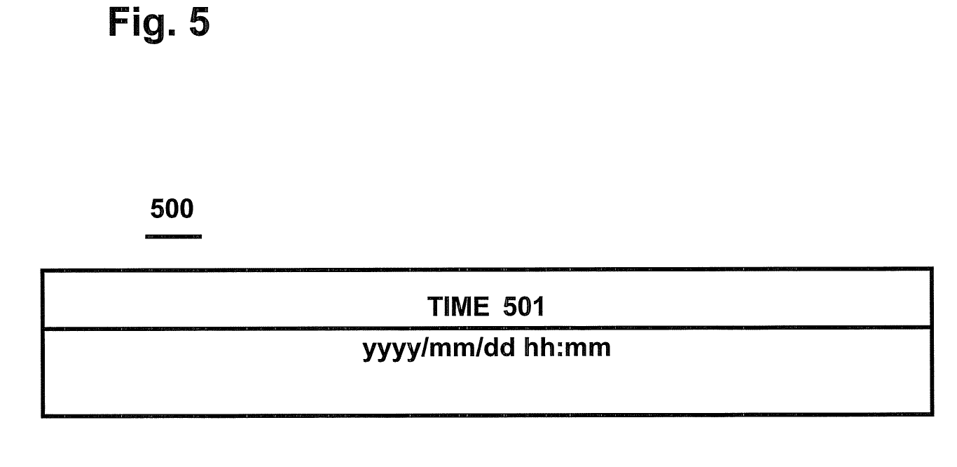

The last time information file 500 is information updated by the MPU 101 on the basis of a time measured by the timer 111. The MPU 101 periodically updates a time 501 illustrated in FIG. 5 on the basis of a time measured by the timer 111. In this case, the USIM 110 does not have a clock function. Thus, the MPU 101 updates the last time information file 500 by periodically writing, to the USIM 110, a time measured by the timer 111 installed in the cellular phone 100.

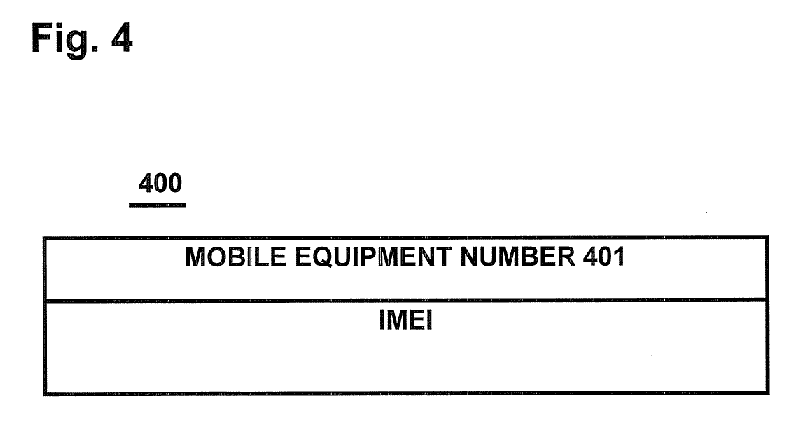

The mobile equipment number file 400 is information for identifying the cellular phone 100 and indicates a mobile equipment number 401, as illustrated in FIG. 4. The cellular phone 100 also stores a mobile equipment number 1021 in the storage unit 102. The MPU 101 reads the mobile equipment number file 400 from the storage area 201 and compares the mobile equipment number 1021 stored in the storage unit 102 with the mobile equipment number 401.

When the mobile equipment number 401 matches the mobile equipment number 1021, the cellular phone 100 can be used by the use of user information such as a telephone number stored in the USIM 110. When the mobile equipment number 401 does not match the mobile equipment number 1021, the cellular phone 100 cannot be used by the use of, for example, a telephone number stored in the USIM 110. User information may include, in addition to information on communication such as a telephone number and a mail address, a user name, address information, and the like set by a user.

The home network selection information file 1303 is information in which a network code is in association with a country code, the network code indicating a network managed by an affiliate carrier that provides a roaming service predetermined by a carrier, the country code indicating a country where roaming is performed. In the home network selection information file 1303, the priorities of pairs of country codes and network codes in association with the country codes are set. In this case, when roaming is performed by the use of the home network selection information file 1303, the MPU 101 determines, in descending order of the priorities of the pairs, whether the pairs can be used. After the MPU 101 determines pairs of country codes and network codes that can be used, the MPU 101 performs roaming, using networks corresponding to the determined country codes and network codes.

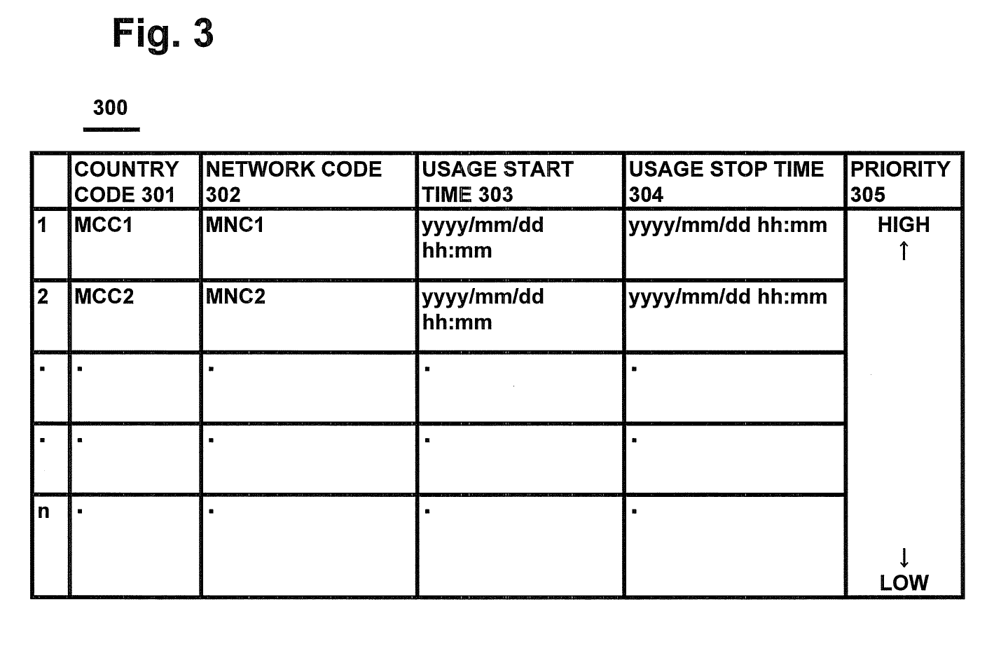

The user preferential network selection information file 300 illustrated in FIG. 3 is information that can be set by a user and in which a country code 301, a network code 302, a usage start time 303, a usage stop time 304, and a priority 305 are in association with each other. A user can set the usage start time 303 and the usage stop time 304 in association with the country code 301 and the network code 302. Roaming can be performed for an available period determined by the usage start time 303 and the usage stop time 304, using a network corresponding to the network code 302. Specifically, a network corresponding to a network code is a carrier network owned by an affiliate carrier that provides a roaming service. In the user preferential network selection information file 300 illustrated in FIG. 3, pairs of the country codes 301 and the network codes 302 are sorted in the order of the priorities used in roaming. The priorities can be properly set by a user. In the embodiment, both a network code that indicates a carrier network and a country code that indicates a country where roaming is performed are identification numbers but are not limited to numbers as long as the network code and the country code are character strings by which a network and a country can be identified.

Moreover, a security lock is set on the usage start time 303 and the usage stop time 304 so that password authentication is required. A password and the like can be set by a user. Thus, since a user cannot change the usage start time 303 and the usage stop time 304 unless the user can enter a correct password, the usage start time 303 and the usage stop time 304 can be prevented from being illegally altered. The service information file 1305 is service information stored in the USIM 110 and is information that indicates an affiliate carrier that provides roaming. The service authorization information file 1306 is information on a service selected by the cellular phone 100. The last registered network information file 1307 is information that indicates a network that was used the last time.

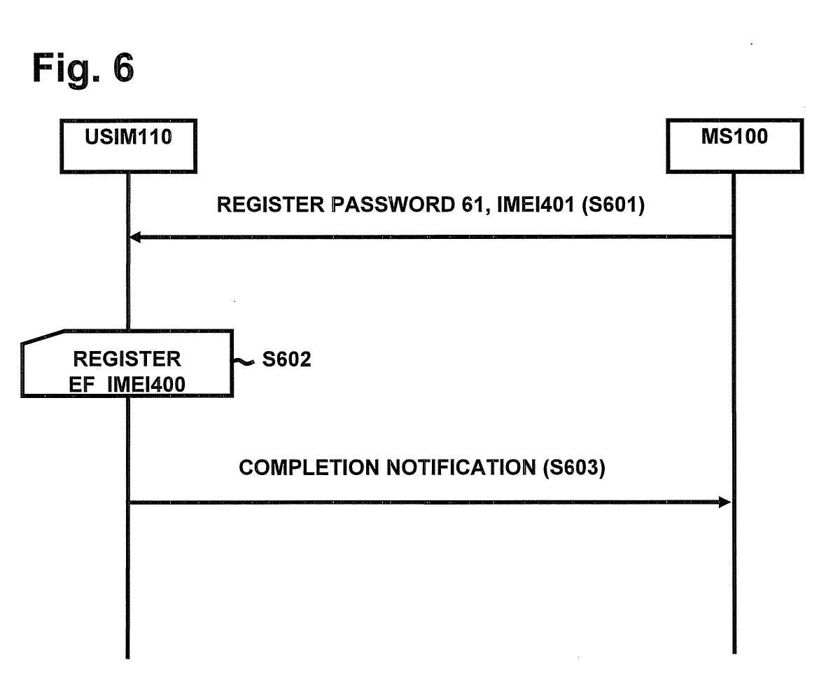

FIG. 6 is a sequence diagram of writing the mobile equipment number 401 according to the embodiment.

The cellular phone 100 requests the USIM 110 to register a password 61 and the mobile equipment number 401 (S601). The USIM 110 registers the password 61 and the mobile equipment number file 400, using the MPU 202 (S602). After the USIM 110 completes the registration of the password 61 and the mobile equipment number file 400, the USIM 110 transmits, to the cellular phone 100, a completion notification that indicates the completion of registration of the password 61 and the mobile equipment number file 400 (S603).

The password 61 and the mobile equipment number 401 are stored in the storage area 201. The password 61 registered in the USIM 110 by the cellular phone 100 is a password to be used to update the mobile equipment number file 400. That is, when the mobile equipment number file 400 is updated, the MPU 202 authenticates the password 61. When a password entered by a user matches the password 61, the MPU 202 permits the mobile equipment number file 400 to be updated.

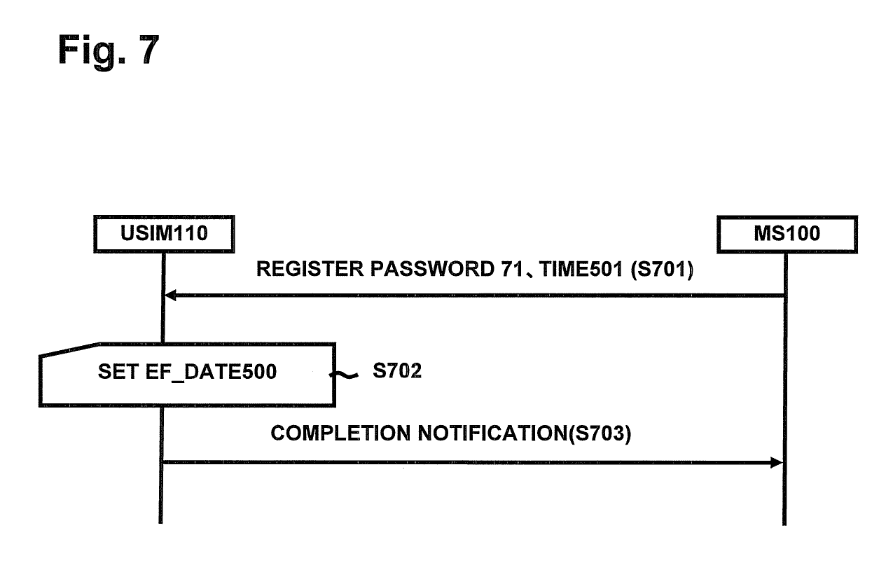

FIG. 7 is a sequence diagram of setting the time 501 according to the embodiment.

The cellular phone 100 requests the USIM 110 to register a password 71 and the time 501 (S701). The USIM 110 sets the password 71 and the time 501, using the MPU 202 (S702). After the USIM 110 completes the registration of the password 71 and the last time information file 500, the USIM 110 transmits, to the cellular phone 100, a completion notification that indicates the completion of registration of the password 71 and the last time information file 500 (S703).

The password 71 is a password to be used to update the last time information file 500. That is, when the last time information file 500 is updated, the MPU 202 authenticates the password 71. When a password entered by a user matches the password 71, the MPU 202 permits the last time information file 500 to be updated.

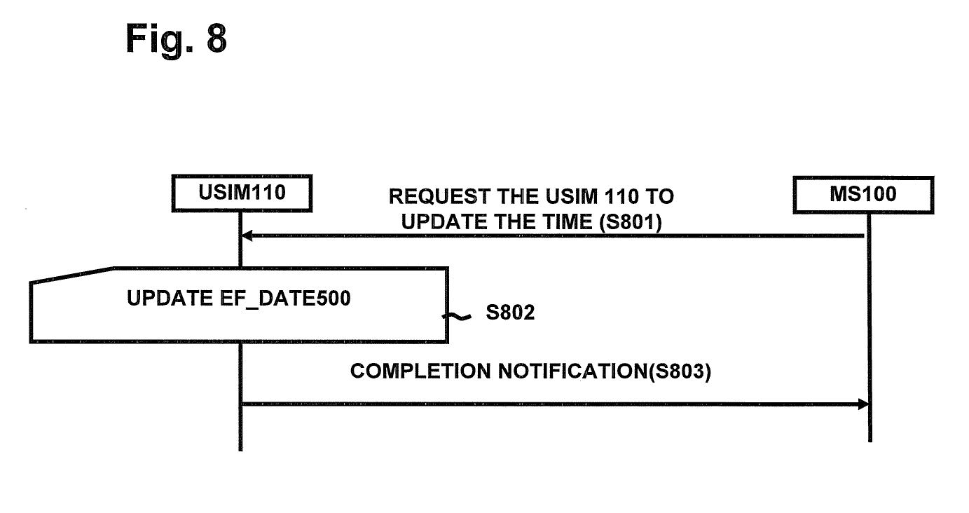

FIG. 8 is a sequence diagram of updating time information according to the embodiment.

The cellular phone 100 periodically transmits, to the USIM 110, a time measured by the timer 111 to request the USIM 110 to update the time 501 (S801).

The USIM 110 updates the last time information file 500, referring to the time that is measured by the timer 111 and is received from the cellular phone 100 (S802). After the USIM 110 has updated the last time information file 500, the USIM 110 transmits, to the cellular phone 100, a completion notification that indicates that the last time information file 500 has been updated (S803).

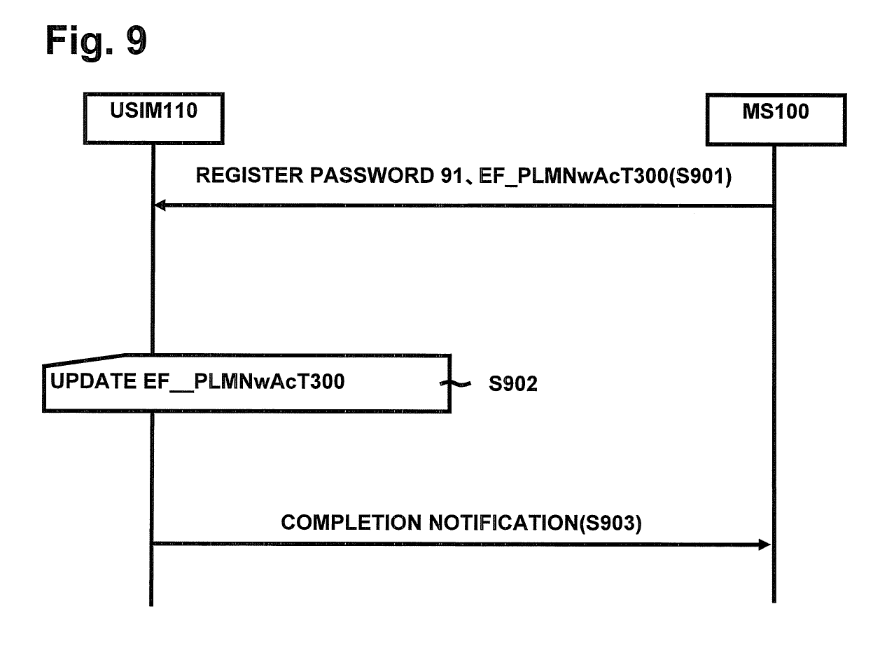

FIG. 9 is a sequence diagram of registering the user preferential network selection information file 300 according to the embodiment.

The cellular phone 100 requests the USIM 110 to register a password 91 and the user preferential network selection information file 300 (S901). The USIM 110 registers the password 91 and the user preferential network selection information file 300, using the MPU 202 (S902). After the USIM 110 completes the registration of the password 91 and the user preferential network selection information file 300, the USIM 110 transmits, to the cellular phone 100, a completion notification that indicates the completion of registration of the password 91 and the user preferential network selection information file 300 (S903).

The password 91 is a password to be used to update the user preferential network selection information file 300. That is, when the user preferential network selection information file 300 is updated, the MPU 202 authenticates the password 91. When a password entered by a user matches the password 91, the MPU 202 permits the user preferential network selection information file 300 to be updated.

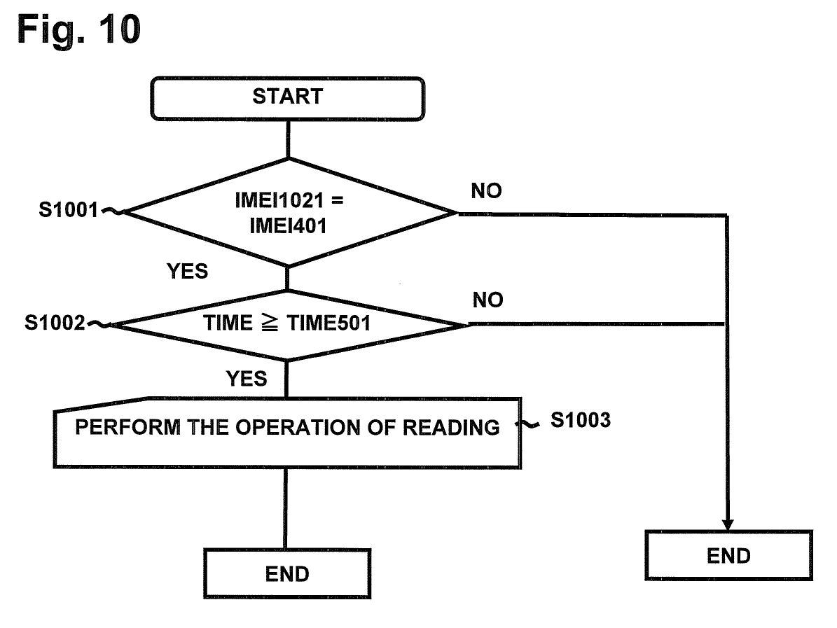

FIG. 10 is a flowchart of an operation of reading the roaming information 1300 according to the embodiment.

The cellular phone 100 first reads the mobile equipment number file 400 stored in the USIM 110. Then, the MPU 101 determines whether the mobile equipment number 1021 stored in the storage unit 102 matches the mobile equipment number 401 (S1001). When the MPU 101 determines that the mobile equipment number 1021 does not match the mobile equipment number 401 (S1001 NO), the cellular phone 100 terminates the operation of reading the roaming information 1300.

When the MPU 101 determines that the mobile equipment number 1021 matches the mobile equipment number 401 (S1001 YES), the MPU 101 determines whether a time measured by the timer 111 is equal to or more than the time 501 in the last time information file 500 (S1002). When the MPU 101 determines that the time measured by the timer 111 is smaller than the time 501 (S1002 NO), the cellular phone 100 terminates the operation of reading the roaming information 1300.

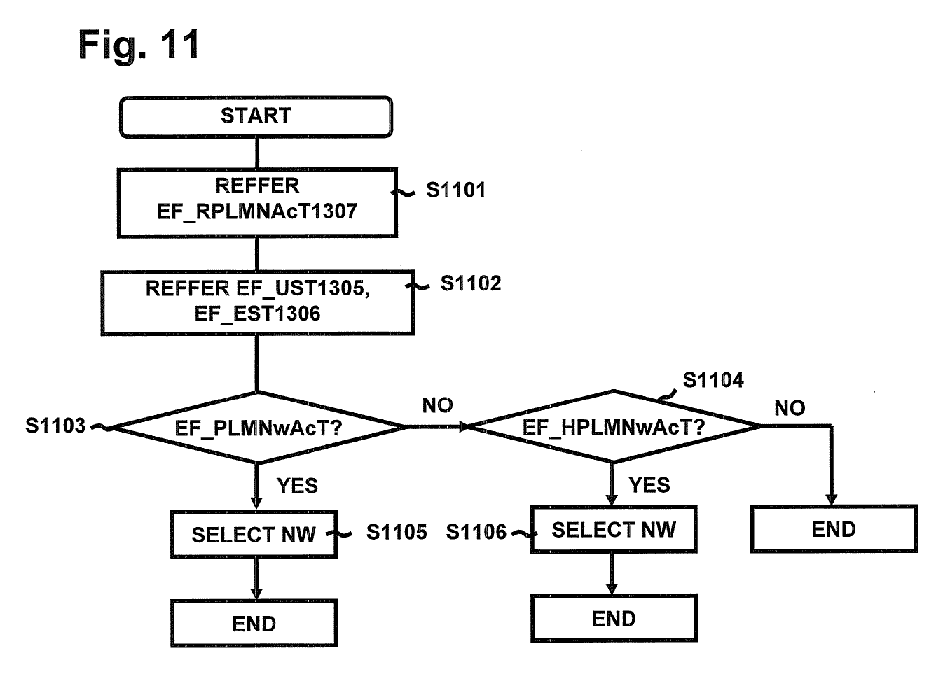

When the MPU 101 determines that the time measured by the timer 111 is equal to or more than the time 501 (S1002 YES), the MPU 101 performs the operation of reading the roaming information 1300 (S1003). The operation of reading the roaming information 1300 is an operation of the cellular phone 100 selecting a network in which roaming is performed and the like on the basis of country information and position information obtained from a base station and the like so as to perform roaming. Thus, the cellular phone 100 can perform roaming communication via a set network. In the reading operation, an operation of selecting the user preferential network selection information file 300 illustrated in FIG. 11 can also be performed.

FIG. 11 is a flowchart of an operation of selecting the user preferential network selection information file 300 according to the embodiment.

The MPU 101 refers to the last registered network information file 1307 stored in the USIM 110 (S1101). Then, the MPU 101 refers to the service information file 1305 and the service authorization information file 1306 (S1102). Then, the MPU 101 determines whether the user preferential network selection information file 300 is registered (S1103).

When the MPU 101 determines that the user preferential network selection information file 300 is registered (S1103 YES), the MPU 101 selects a network in which roaming can be performed in response to the priorities of networks described in the user preferential network selection information file 300 (S1105).

When the MPU 101 determines that the user preferential network selection information file 300 is not registered (S1103 NO), the MPU 101 determines whether the home network selection information file 1303 is registered (S1104). When the home network selection information file 1303 is registered (S1104 YES), the home network selection information file 1303 is selected, and a network in which roaming can be performed is selected in response to the priorities of networks described in the home network selection information file 1303 (S1106).

When the MPU 101 determines that the home network selection information file 1303 is not registered (S1104 NO), the MPU 101 terminates the operation without selecting any network in which roaming is performed.

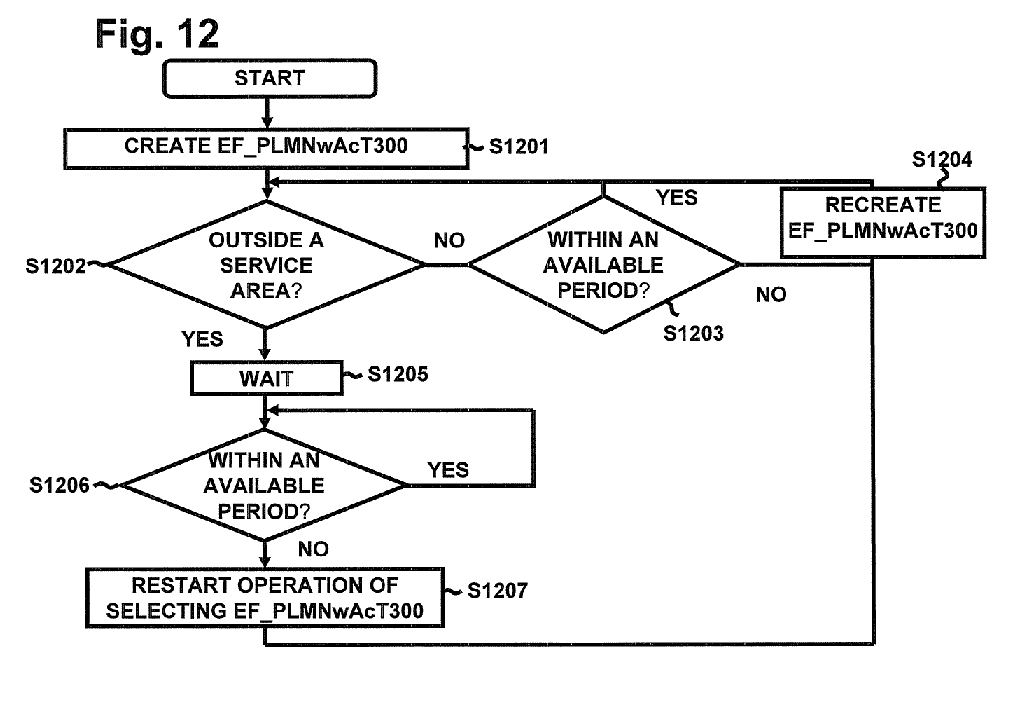

FIG. 12 is a flowchart of an operation of updating the user preferential network selection information file 300 according to the embodiment.

The MPU 202 creates the user preferential network selection information file 300 on the basis of input from the operation unit 106 and the like (S1201). Then, the MPU 101 determines whether the cellular phone 100 is located outside a service area (S1202). For example, it is determined whether the transmitter and receiver unit 103 can receive position information and the like from a base station and the like to determine whether the cellular phone 100 is located outside the service area.

When the MPU 101 determines that the cellular phone 100 is not located outside the service area (S1202 NO), the MPU 101 determines whether a time measured by the timer 111 is within an available period of a network selected to perform roaming (S1203). When the MPU 101 determines that the time measured by the timer 111 is within the available period of the network selected to perform roaming (S1203 YES), the MPU 101 again determines whether the cellular phone 100 is located outside the service area (S1202). When the time measured by the timer 111 is not within the available period of the network selected to perform roaming (S1203 NO), the MPU 202 re-creates the user preferential network selection information file 300 (51204). Thus, the MPU 202 can determine, by reading the last time information file 500 and the user preferential network selection information file 300 from the storage area 201 and comparing the last time information file 500 with the user preferential network selection information file 300, whether the network to be used for roaming can be used.

When the MPU 101 determines that the cellular phone 100 is located outside the service area (S1202 YES), the cellular phone 100 waits until the cellular phone 100 comes into the service area (S1205). Then, the MPU 101 determines whether the time measured by the timer 111 is within the available period of the network selected to perform roaming (S1206). When the MPU 101 determines that the time measured by the timer 111 is not within the available period of the network selected to perform roaming (S1206 NO), the MPU 101 restarts the operation of selecting the user preferential network selection information file 300 (51207). Then, the MPU 202 re-creates the user preferential network selection information file 300 (Sl204). When the MPU 101 determines that the time measured by the timer 111 is within the available period of the network selected to perform roaming (S1206 YES), the MPU 101 again determines whether the time measured by the timer 111 is within the available period of the network selected to perform roaming (S1206).

An operation performed by selecting means according to the present invention is included in operations performed by the MPU 101 in the embodiment. Moreover, an operation performed by determining means according to the present invention is included in the operations performed by the MPU 101 in the embodiment. Moreover, an operation performed by communicating means according to the present invention is included in operations performed by the transmitter and receiver unit 103 in the embodiment. Moreover, an operation performed by storing means according to the present invention is included in operations performed by the storage area 201 according to the embodiment. Moreover, identification information in the present invention corresponds to the mobile equipment number file 400 in the embodiment.

### INDUSTRIAL APPLICABILITY

A communication device according to the present invention sets an available period of a network used to communicate with another communication device. Thus, the communication device according to the present invention is extremely useful in performing communication in a cellular phone that has a roaming function.

All examples and conditional language recited herein are intended for pedagogical purposes to aid the reader in understanding the invention and the concepts contributed by the inventor to furthering the art, and are to be construed as being without limitation to such specifically recited examples and condition, nor does the organization of such examples in the specification relate to a showing of superiority and inferiority of the invention. Although the embodiment of the present inventions have been described in detail, it should be understood that the various changes, substitutions, and alternations could be made hereto without departing from the spirit and scope of the invention.

What is claimed is:

1. A communication apparatus for communicating with another apparatus via a network, the communication apparatus comprising:
a storage unit for storing identification information of a plurality of networks and areas where the networks are deployed, respectively, and information of time periods while communication over the networks is permissible for the communication apparatus, respectively; and
a processor to control communication with the another apparatus in accordance with a process including:
selecting one of the networks which is currently connectable and available to communicate with the another apparatus on the basis of the identification information of the networks and the areas,
determining whether the present time is within one of the time periods for the selected one of the networks, and
either inhibiting communication with the another apparatus via the selected network when the present time is not within the period of time, or allowing communication with the another apparatus via the selected network when the present time is within the period of time.

2. The communication apparatus according to claim 1, further comprising:
a clock for measuring the present time; and
a USIM card for storing identification information of the communication apparatus and storing the present time measured by the clock periodically.

3. The communication apparatus according to claim 2, wherein the processor updates the present time stored in the USIM card periodically.

4. A communication method for controlling communication between a communication apparatus and another communication apparatus via a network, the communication method comprising:
selecting one of the networks which is currently connectable and available to communicate with the another apparatus on the basis of identification information of a plurality of networks and the areas where the networks are deployed, respectively, and information of time periods while communication over the networks is permissible for the communication apparatus, respectively, the identification information of a plurality of networks and the areas and the information of time periods being stored in a storage unit mounted on the communication apparatus;
determining whether the present time is within one of the time periods for the selected one of the networks; and
either inhibiting communication with the another apparatus via the selected network when the present time is not within the period of time, or allowing communication with the another apparatus via the selected network when the present time is within the period of time.

5. A computer-readable recording medium that stores a communication program for controlling communication between a communication apparatus and another communication apparatus via a network by controlling the communication apparatus according to a process comprising:
selecting one of the networks which is currently connectable and available to communicate with the another apparatus on the basis of identification information of a plurality of networks and the areas where the networks are deployed, respectively, and information of time periods while communication over the networks in permissible for the communication apparatus, respectively, the identification information of a plurality of networks and the areas and the information of time periods being stored in a storage unit mounted on the communication apparatus;
determining whether the present time is within one of the time periods for the selected one of the networks; and
either inhibiting communication with the another apparatus via the selected network when the present time is not within the period of time, or allowing communication with the another apparatus via the selected network when the present time is within the period of time.
